(19) United States
(12) Patent Application Publication
(10) Pub. No.: US 2009/0205385 A1
(43) Pub. Date: Aug. 20, 2009

(54) Method and Assembly to Prevent Impact-Driven Lock Manipulation of Cylinder Locks

(76) Inventor: John P. Cozzolino, Miller Place, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/031,379

(22) Filed: Feb. 14, 2008

(51) Int. Cl. E05B 27/02

(52) U.S. Cl. 70/358

(57) ABSTRACT

A cylinder lock designed to prevent unauthorized manipulation of the lock using impact-driven methods such as a bump key. The cylinder lock has a plurality of first pin assemblies and at least one second pin assembly, containing a key pin, driver pin, and an elastomer plug, that is adapted so as to alter the linear displacement thereof through the use of the elastomer plug. When an impact-driven blow of a given intensity is applied so as to linearly displace the key and driver pins, the elastomer plug effectively absorbs the energy of the impact and fails to compress sufficiently to allow the key pin to clear the shear line, thus preventing the unauthorized manipulation of the lock.

### FIELD OF THE INVENTION

The present invention relates to pin tumbler cylinder locks having pins that are linearly displaceable, and, more particularly, to a method and assembly for preventing manipulation of pin tumbler locks using impact based methods such as bumping.

### BACKGROUND OF THE INVENTION

Cylinder locks are well known in the art. They typically have a cylindrical core that must rotate within a cylinder to allow the lock to open. The core in a cylinder lock is held in place by one of a number of different locking mechanisms, including, for example, the pin tumbler lock, the wafer tumbler lock, and the disc tumbler lock. The pin tumbler lock is generally the considered the most popular of these locking mechanisms.

A conventional pin tumbler cylinder lock has an outer casing with a cylindrical hole in which a core is housed. The core has a slot known as the keyway at one end that allows the key to enter the plug. The lock will not open unless the core is rotated following insertion of the key.

Each core typically has a series of vertical holes, normally five or six, drilled into it. Within these holes are key pins, or tumbler pins, which are rounded at the bottom to permit the key to slide over them easily. The holes are thus also referred to as pin chambers.

Above the key pins are separate pins known as driver pins. Simple locks typically have only one driver pin for each key pin. More complicated locks, such as those allowing use of a master key, have additional driver pins known as spacer pins. These driver and spacer pins reside in vertical holes in the cylinder that line up with the vertical holes in the core. Together, the key pin and driver pin, along with any spacer pins, residing in the same pin chamber are referred to as the pin assembly.

When the core and cylinder are assembled, the pins in the pin assembly are pushed down into the core by the springs. The point where the core and cylinder meet is called the shear line. With a key properly cut and inserted into the groove on the end of the core, the pins will translate, causing them to align exactly at the shear line. This allows the core to rotate, thus opening the lock. When the key is not in the lock, the pins straddle the shear line, preventing the core from rotating. Sets of locks with a master key will have one set of pin positions that reach the shear line which are identical to the others in the set and one set that is unique to that specific lock.

One problem posed by the traditional design of pin tumbler cylinder locks is that they are vulnerable to various methods of unauthorized manipulation. One of the most popular methods of unauthorized manipulation is commonly known as “bumping”. Bumping the lock typically involves the use of either a Bumpgun or Bumpkey.

A Bumpgun consists of a narrow, strong metallic portion that is inserted into the lock keyway instead of a key, and a gun-like portion which, when triggered, imparts the force of the impact along the length of the metallic portion. In conjunction with the Bumpgun device, a tension rod is used to apply rotational force to the core while the Bumpgun is being impacted. When the Bumpgun is activated, the force of the blow is transmitted to the driver pins which are knocked out of position (translating in their holes), allowing the core to be rotated slightly with the tension rod to keep the pins from returning to their neutral position. Once the pins have all cleared the shear line in this manner, the core may be rotated and the lock may be opened.

Although using a Bumpgun requires some level of expertise, a simpler burglary tool, known as the Bumpkey, has recently gained some prominence. The Bumpkey essentially consists of a key blank which has been cut to the deepest setting for that particular lock brand. Once the key is inserted in the lock, it is slammed into the lock using some sort of mallet or hammer which imparts a similar force to the driver pins as in the Bumpgun method, while the key is simultaneously being rotated. Proper bumping will force the driver pins to clear the shear line and allow the core to rotate in the cylinder to open the lock.

Therefore, it is desirable to provide a method and assembly for preventing manipulation of conventional pin tumbler locks using bumping without having to extensively modify the existing lock architecture.

### BRIEF SUMMARY OF THE INVENTION

Accordingly, it is an object of the present invention to overcome the above-mentioned lock manipulation problems and provide a lock assembly for preventing unauthorized manipulation using known bumping methods, or any other method that is based on impact.

Furthermore, it is an object of the present invention to provide a mechanism for preventing unauthorized manipulation of a lock using bumping methods that is both simple and easily adaptable to all pin tumbler locks without extensive modifications.

In accordance with a preferred embodiment of the present invention, there is provided, a pin-tumbler cylinder lock having a body, in which a plug with a profiled, axially extending key slot is rotatably arranged, and in which the body and the plug are provided with a plurality of pin chambers approximately perpendicular to the axis of the plug, in which pin chambers a first plurality of pin assemblies and at least one second pin assembly are provided, and wherein each said first pin assembly comprise a key pin, a driver pin, and a biasing spring, and wherein each wherein each of the key pins and driver pins in each said first pin assembly is linearly displaceable within said pin chamber, each said pin chamber having a length, and wherein each driver pin crosses a shear line to prevent rotation of the key slot when in a locked position, and wherein the at least one second pin assembly comprises:

a driver pin linearly displaceable within said pin chamber;

a key pin linearly displaceable within said pin chamber; and

an elastomer plug having an axial spring rate of 17-25 lbf/inch, arranged so that when said key slot is in said locked position there is an axial take-up of 10% to 15% of the length of the pin chamber.

In a preferred embodiment, the second pin assembly, containing a key pin and a driver pin, is adapted so as to alter the linear displacement thereof through the use of an elastomer plug. When an impact-driven blow of a given intensity is applied so as to linearly displace the key and driver pins, the elastomer plug effectively absorbs the energy of the impact and fails to compress sufficiently to allow the driver pin to clear the shear line. This prevents the unauthorized manipulation of the lock using an impact-driven means.

### BRIEF DESCRIPTION OF THE DRAWINGS

Other features and advantages of the present invention will become apparent from the drawings and description contained herein below, in which like reference characters refer to like elements and in which:

FIG. 1 presents a cross-sectional view of a prior art common pin tumbler lock, illustrating how a correctly fitting key may be inserted into the lock to allow the core to rotate freely.

FIG. 2, presents a cross-sectional view of a prior art common pin tumbler lock, schematically illustrating the movement of the key and driver pins following manipulation by a bumpkey that has been impacted by a hammer blow.

FIG. 3 schematically illustrates a cross-sectional view of a pin tumbler lock implementing a preferred embodiment of the present invention, with no key inserted;

FIG. 4 schematically illustrates a cross-sectional view of the pin tumbler lock of FIG. 3 after the impact-driven blow has been delivered to the bump key; and

FIG. 5 schematically illustrates a cross-sectional view of the pin tumbler lock of FIG. 3, showing how a correctly fitting key will allow the core to rotate freely.

### DETAILED DESCRIPTION OF THE INVENTION

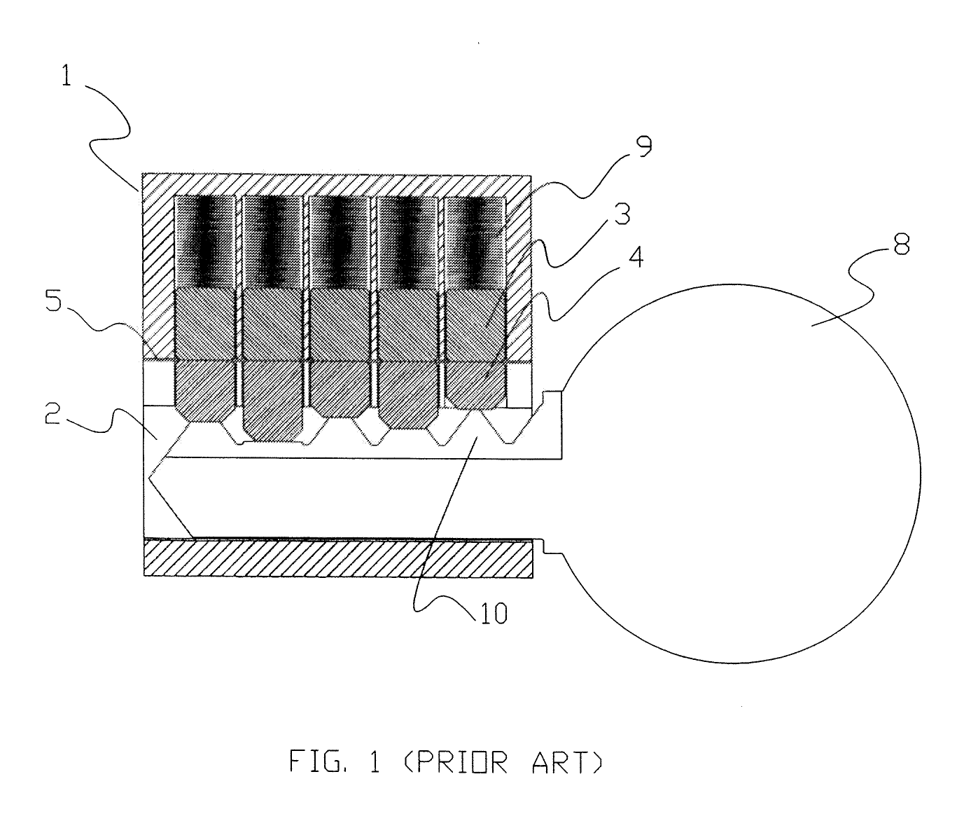

A description of preferred embodiments of the present invention follows. Referring to FIG. 1, there is shown a cylinder lock having a plurality of first pin assemblies provided in pin chambers, each first pin assembly having a key pin 4, a driver pin 3, and biasing spring 9, respectively.

As is typical in common pin tumbler locks, the length of the key pin 4, driver pin 3, and biasing spring 9 varies in each first pin assembly to accommodate key cuts 10 of different heights. As shown in FIG. 1, when a correctly fitting key 8 is inserted into a proximal opening in a key slot 2 within the lock, each key cut 10 will force each respective biasing spring 9 to compress, thereby allowing the driver pin 3 to clear the shear line 5. When all the driver pins have cleared the shear line 5 the key slot, as well as the plug or core, may be rotated and the lock unlocked.

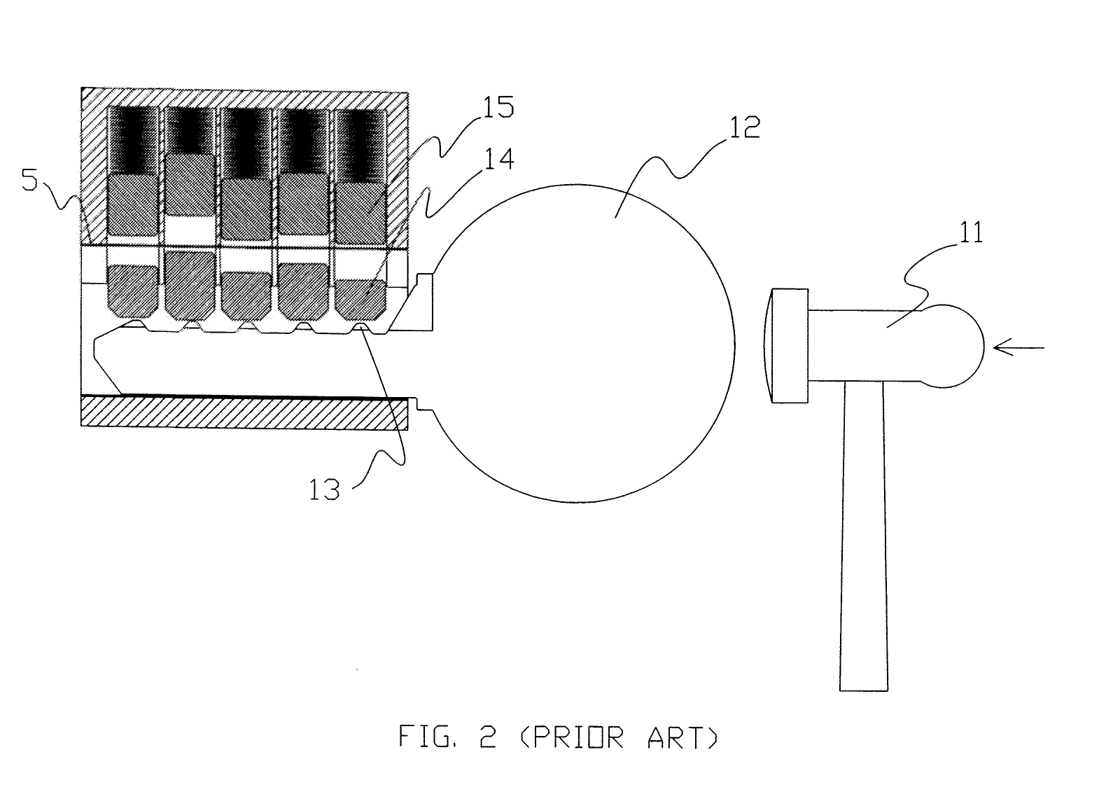

As shown in FIG. 2, a typical tool for lock manipulation, known as a bump key 12, is typically a key blank where all of the key cuts 13 are cut to the deepest setting to ensure each key cut/tooth 13 will make contact with a respective key pin 14. When the bump key is struck with a hammer 11, or similar object, the force of the impact is transmitted through the bump key 12 to the key pins 14 and driver pins 15 so that they are knocked out of position. When they are knocked out of position so that the driver pins clear the shear line 5, as shown in FIG. 2, the bump key can be manipulated to force the key slot to rotate slightly. This prevents the pins from returning to their locking position, and the key slot can then be freely rotated so that lock is opened.

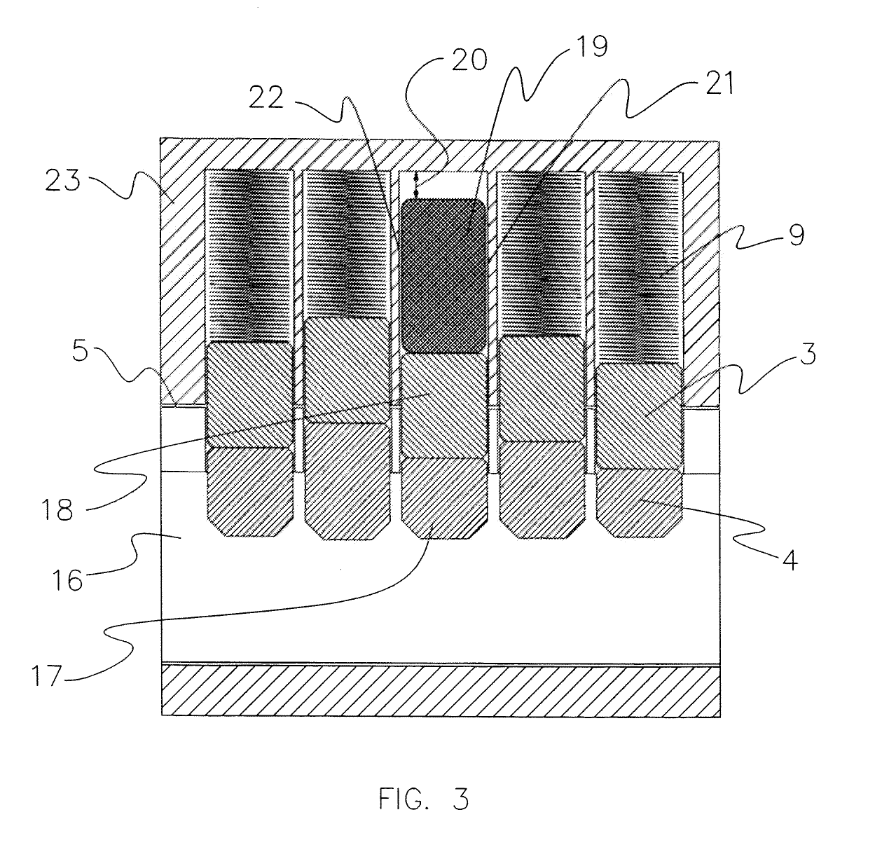

FIG. 3 shows a close-up view of a pin tumbler lock 23 in a locked position implementing a preferred embodiment of the present invention, wherein the lock includes at least one second pin assembly having an elastomer plug 19, a key pin 17 and a driver pin 18. The elastomer plug 19 is made of a rubber-like material which allows it to be stretched or compressed significantly yet return to its original shape without incurring any permanent deformation. Of particular importance in choosing a material for the elastomer bumper are the material's chemical resistance, aging characteristics, and reaction to temperature changes of the material. Typical materials suitable for use as the elastomer plug 19 are fluorosilicone, nitrile (Buna-N), fluoroelastomer polymers, polyurethane, hydrogenated nitrile (HNBR), fluorocarbon elastomer (low temperature), carboxylated nitrile, urethane, and cellular urethane foam.

Unlike a typical biasing spring, an elastomer plug offers non-linear stiffness characteristics. Thus, the stiffness of the elastomer plug increases with compression and it is capable of absorbing kinetic energy rapidly. This is due to the fact that the elastomer's modulus of elasticity increases with compressive deformation. This makes a properly fitted elastomer plug especially resistant to lock bumping.

In a preferred embodiment of the present invention, as shown in FIG. 3, the lock includes a first plurality of first pin assemblies and at least one second pin assembly. The second pin assembly will include an elastomer plug 19 having an axial spring rate of between 17-25 lbf/in. Unlike a typical biasing spring 9, the elastomer plug can not be pre-compressed, and must reside loosely in the pin chamber with sufficient axial and diametrical clearance to allow for take-up during normal key insertion. It must be elastic enough to allow key insertion to be smooth and easy, yet stiff enough to keep the drive pin from clearing the shear line 5 in the event of a bump key related impact. In a preferred embodiment of the present invention having an elastomer plug with an axial spring rate of between 17-25 lbf/in, this axial take-up 20 ranges from between 10-15% of the length of the pin chamber and the diametrical clearance 21 (the distance between the surface of the elastomer plug 19 and the wall of the modified pin assembly chamber 22) of between 4% and 6% of the diameter of the elastomer plug 19.

In an alternate preferred embodiment, the second pin assembly includes one of the shorter key pins 17 in the pin arrangement. One need not select the very shortest key pin in the lock provided that a shorter key pin is not used in any first pin assembly located distally to the second pin assembly within the lock. If a shorter pin is located in a first pin assembly deeper within the lock than the modified pin assembly, then insertion of a key fitted for the lock will be more difficult due to the high key cut causing an over-compression of the elastomer plug, leading to accelerated lock wear.

It is also preferable for the second pin assembly to include one of the shorter key pins 17 in the lock to ensure that a typical bump key 12 is incapable of driving the driver pin 18 to clear the shear line when it is inserted into the key entry 16 and impacted by a bumping device. A longer key pin is easier for a bump key, with its short key cuts, to deflect to the shear line 5 during an attempted bumping.

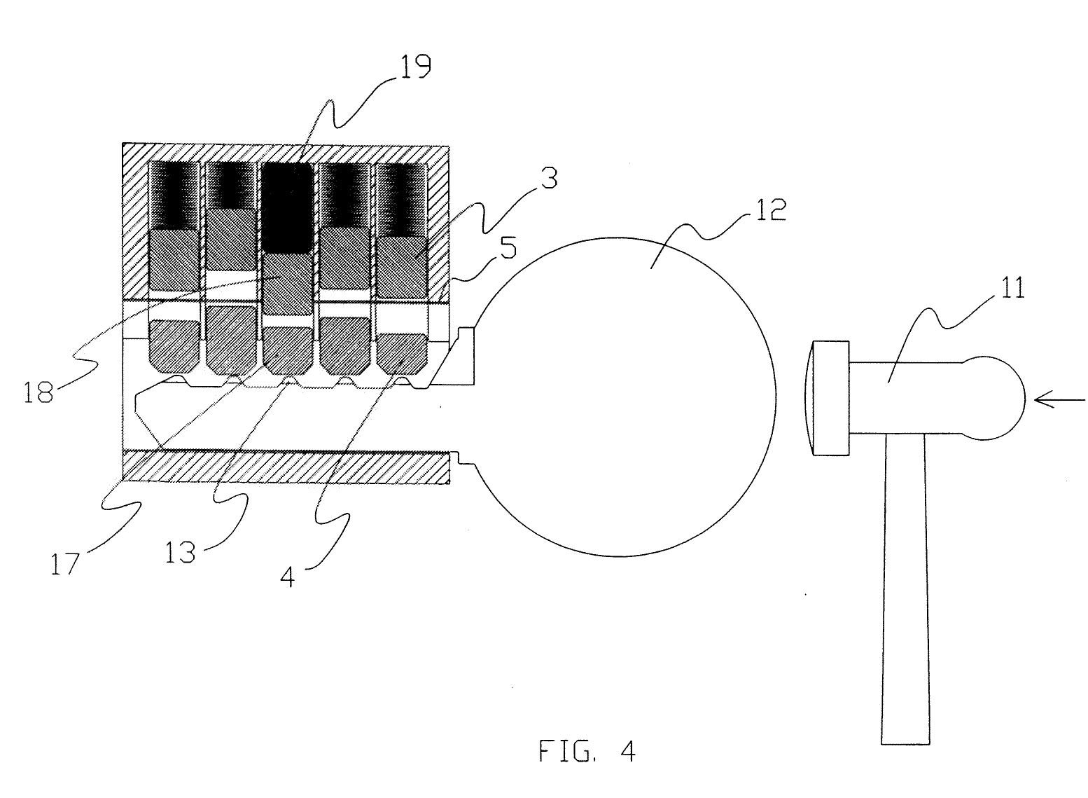

FIG. 4 illustrates a schematic of the present invention foiling an unauthorized manipulation of the lock using a bump key as described above. The impact of the hammer 11 striking the bump key 12 causes the driver pins 3 in the first pin assemblies to clear the shear line 5, but the impact does not provide enough force to linearly displace the elastomer plug sufficiently to allow the driver pin 18 in the second pin assembly to clear the shear line 5. As shown in FIG. 4, when the elastomer plug 19 has an uncompressed state and is positioned against a base of said pin chamber, an end of the driver pin 18 crosses said shear line by 0.02 to 0.04 inches to prevent rotation of the cylinder lock. This prevents the lock from rotating using the bump key method or other similar impact driven lock manipulation methods.

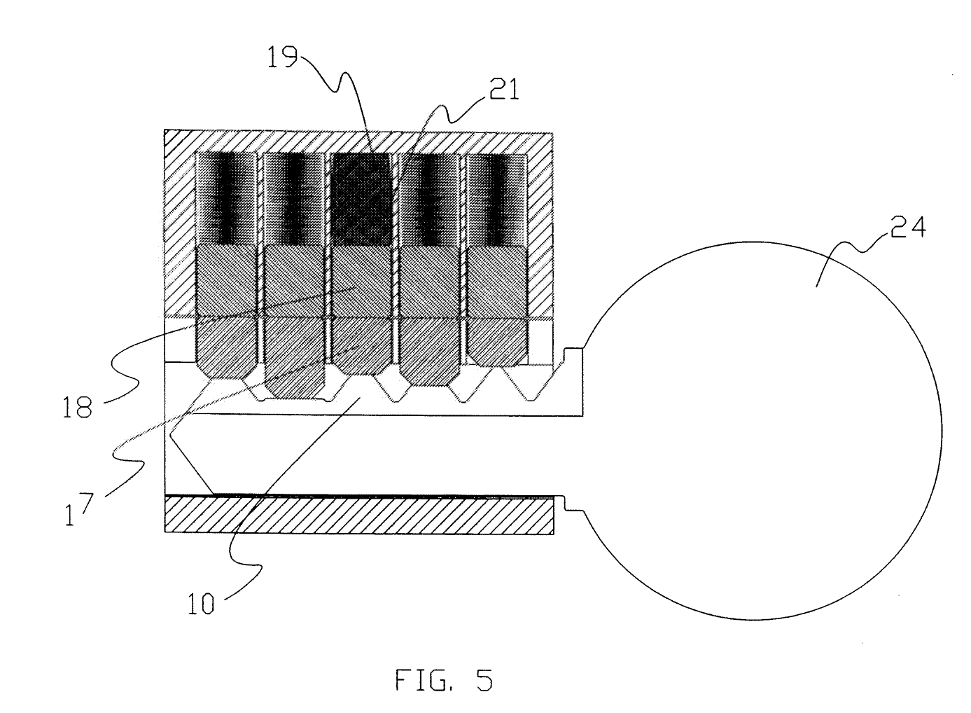

FIG. 5 shows a schematic of the present invention wherein a correctly fitting key 24 is inserted into the lock so that the lock may rotate. FIG. 5 shows how the elastomer plug in the second pin assembly will compress to allow the driver pin 18 to clear the shear line. The optimal diametrical clearance 15 allows the elastomer plug to compress by permitting it to expand enough so that it has enough room to expand when it is compressed by the axial movement of the pins 17 and 18 in response to the key cut 10.

Having described the invention with regard to certain specific embodiments, it is understood that various modifications may be made by those of ordinary skill in the art without departing from scope or spirit of the invention.

I claim:

1. A pin-tumbler cylinder lock having a body, in which a plug with a profiled, axially extending key slot is rotatably arranged, and in which the body and the plug are provided with a plurality of pin chambers approximately perpendicular to the axis of the plug, in which pin chambers a first plurality of pin assemblies and at least one second pin assembly are provided, and wherein each said first pin assembly comprise a key pin, a driver pin, and a biasing spring, and wherein each of the key pins and driver pins in each said first pin assembly is linearly displaceable within said pin chamber, each said pin chamber having a length, and wherein each driver pin crosses a shear line to prevent rotation of the key slot when in a locked position, and wherein the at least one second pin assembly comprises:
a driver pin linearly displaceable within said pin chamber;
a key pin linearly displaceable within said pin chamber; and
an elastomer plug having an axial spring rate of 17-25 lbf/inch, arranged so that when said key slot is in said locked position there is an axial take-up of 10% to 15% of the length of the pin chamber.

2. The lock of claim 1, wherein the key pin in the at least one second pin assembly and the key pins in the first pin assemblies each have a length, and wherein the length of the key pin in the second pin assembly is shorter than the length of any key pin in the first pin assemblies.

3. The lock of claim 1, wherein said key slot further comprises a distal end and a proximal end, and wherein the proximal end has an opening in which a key may be inserted, and wherein the key pin in the at least one second pin assembly and the key pins in the first pin assemblies each have a length, and wherein the length of the key pin in the at least one second pin assembly is shorter than the length of any key pin found in any pin assembly located distally to the at least one second pin assembly.

4. The lock of claim 1, wherein when the elastomer plug has an uncompressed state and is positioned against a base of said pin chamber, the driver pin disposed in the same pin chamber as the elastomer plug crosses said shear line by 0.02 to 0.04 inches to prevent rotation of the key slot.

5. The lock of claim 1, wherein the elastomer plug has a diameter and each of said pin chambers has a wall, and wherein the at least one second pin assembly further comprises a diametrical clearance between the wall of the pin chamber and the elastomer plug of between 4% and 6% of the diameter of the elastomer plug.

6. The pin tumbler lock of claim 1, wherein the elastomer plug comprises urethane.

7. The pin tumbler lock of claim 1, wherein the elastomer plug comprises carboxylated nitrile.

8. The pin tumbler lock of claim 1, wherein the elastomer plug comprises afluorocarbon elastomer (low temperature).

9. The pin tumbler lock of claim 1, wherein the elastomer plug comprises hydrogenated nitrile (HNBR).

10. The pin tumbler lock of claim 1, wherein the elastomer plug comprises polyurethane.

11. The pin tumbler lock of claim 1, wherein the elastomer plug comprises a fluoroelastomer polymer.

12. The pin tumber lock of claim 1, wherein the elastomer plug comprises nitrile (Buna-N).

13. The pin tumber lock of claim 1, wherein the elastomer plug comprises fluorosilicone.

14. The pin tumber lock of claim 1, wherein the elastomer plug comprises cellular urethane foam.
